(19) United States
(12) Patent Application Publication
(10) Pub. No.: US 2026/0208545 A1
(43) Pub. Date: Jul. 23, 2026

(54) Automatic Vehicle Buoyancy System

(71) Applicants: David Shaheen, Sydney (CA); Rimvydas Baltrusiunas, Fonthill (CA)

(72) Inventors: David Shaheen, Sydney (CA); Rimvydas Baltrusiunas, Fonthill (CA)

(21) Appl. No.: 19/442,025

(22) Filed: Jan. 7, 2026

Related U.S. Application Data
(60) Provisional application No. 63/747,467, filed on Jan. 21, 2025.

(51) Int. Cl. B60F 3/00; B60R 21/01; B60R 21/00

(52) U.S. Cl. CPC B60F 3/0038; B60R 21/01; B60R 2021/0016

(57) ABSTRACT

An automatic vehicle buoyancy system is provided. The system is comprised of an integrated flotation mechanism for preventing the complete submersion of vehicles during water ingress events. The system comprises a plurality of buoyancy modules configured to be integrated into various locations on a vehicle. Each buoyancy module comprises one or more inflatable airbags contained within a housing, at least one high-pressure gas cylinder for inflation, and conduits that channel inflation media from the gas source to the airbags. The system further comprises one or more submersion sensors capable of detecting hydrostatic pressure or other water ingress indicators, which are electronically connected to solenoid valves that control the release of compressed gas into the airbags. Upon detecting submersion, the system initiates automatic inflation of the airbags, causing the housing to open via integrated exit structures, thereby enabling rapid airbag deployment.

### CROSS-REFERENCE TO RELATED APPLICATION

The present application claims priority to, and the benefit of, U.S. Provisional Application No. 63/747,467, which was filed on January 21, 2025, and is incorporated herein by reference in its entirety.

### FIELD OF THE INVENTION

The present invention relates generally to the field of vehicle floatation devices. More specifically, the present invention relates to a vehicle buoyancy system that functions to prevent complete vehicle submersion during water ingress events by automatically deploying inflatable airbags that provide sufficient buoyant force to stabilize the vehicle near the water surface. Accordingly, the present disclosure makes specific reference thereto. Nonetheless, it is to be appreciated that aspects of the present invention are also equally applicable to other like applications, devices, and methods of manufacture.

### BACKGROUND

Incidents involving vehicles submerged in water present significant safety and environmental concerns. When a vehicle becomes submerged, occupants are often unable to exit the vehicle quickly enough, resulting in serious injuries or fatalities. This is particularly critical in scenarios involving rapid water ingress from flooding, bridge collapses, or accidental water entry during transportation. Traditional vehicle designs do not include mechanisms to prevent sinking and therefore do not assist occupants during such emergencies. In addition to human safety risks, submerged vehicles contribute to environmental contamination due to the leakage of fuel, lubricants, and other hazardous fluids. Recovery of these vehicles is often complex, requiring specialized equipment and personnel, and can incur significant financial and logistical burdens. These recovery operations are time-sensitive, especially in ecologically sensitive regions where prolonged exposure of sunken vehicles may cause irreversible damage. Although there have been various flotation devices developed for marine use, few address integrated, automated solutions for terrestrial and aerial vehicles. The absence of a comprehensive, built-in flotation mechanism increases both the risk to human life and the long-term impact on the environment.

Therefore, there exists a long-felt need in the art for an automatic vehicle buoyancy system that prevents full vehicle submersion during water ingress emergencies. There also exists a long-felt need in the art for an automatic vehicle buoyancy system that provides automated activation using onboard sensors without user intervention. Moreover, there exists a long-felt need in the art for an automatic vehicle buoyancy system that reduces environmental contamination and the logistical burden of vehicle recovery.

The subject matter disclosed and claimed herein, in one embodiment thereof, comprises an automatic vehicle buoyancy system. The system is comprised of an integrated flotation mechanism for preventing the complete submersion of vehicles during water ingress events. The system comprises a plurality of buoyancy modules configured to be integrated into various locations on a vehicle. Each buoyancy module comprises one or more inflatable airbags contained within a housing, at least one high-pressure gas cylinder for inflation, and conduits that channel inflation media from the gas source to the airbags. The system further comprises one or more submersion sensors capable of detecting hydrostatic pressure or other water ingress indicators, which are electronically connected to solenoid valves that control the release of compressed gas into the airbags. The sensors may be calibrated to activate at specific depths and are strategically placed at low points in the vehicle. Upon detecting submersion, the system initiates automatic inflation of the airbags, causing the housing to open via integrated exit structures, thereby enabling rapid airbag deployment. The deployed airbags generate sufficient buoyant force to elevate and stabilize the vehicle near the water surface, thereby preventing full submersion and facilitating occupant safety and vehicle retrieval.

In this manner, the automatic vehicle buoyancy system of the present invention accomplishes all the forgoing objectives and provides a system that detects water ingress and initiates a rapid flotation response that stabilizes a vehicle before full submersion of the vehicle occurs. The integration of inflatable buoyancy modules with strategically placed airbags and automated solenoid valves on the vehicle ensures activation without occupant intervention, thereby enhancing response speed and reliability. Furthermore, by preventing vehicle submersion, the system minimizes the likelihood of hazardous fluid leakage into aquatic environments and significantly reduces the need for complex recovery operations. As a result, the automatic vehicle buoyancy system offers a comprehensive solution to the problems of occupant entrapment, environmental damage, and costly salvage efforts.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an automatic vehicle buoyancy system. The system is designed to prevent full submersion of a vehicle in the event of water ingress or sinking by detecting submersion conditions and rapidly deploying inflatable buoyancy components from the vehicle to maintain the vehicle at or near the water's surface. The flotation system is intended to reduce the risk of occupant entrapment and assist in post-incident recovery by stabilizing the vehicle in a buoyant state. The flotation system is configured for use in various vehicles, including terrestrial vehicles such as automobiles, trucks, and buses, as well as aerial vehicles such as airplanes and helicopters. The flotation system may be integrated during manufacturing or retrofitted into existing vehicles.

The flotation system is comprised of a plurality of buoyancy modules, each comprising one or more inflatable airbags, a containment housing, at least one inflation cylinder, and one or more connecting conduits. The airbags are stored in a compressed state within the housing and may be positioned in areas such as wheel wells, the chassis, door panels, roof structure, engine compartment, or rear compartment of the vehicle. Each housing includes an airbag exit structure that permits rapid deployment of the airbags.

Inflation of the airbags is facilitated by gas cylinders storing pressurized media such as carbon dioxide, nitrogen, or other gases, which are delivered to the airbags through conduits. Activation of the buoyancy modules is controlled by submersion sensors electronically integrated into the vehicle's computer system. The sensors may detect water depth and are configured with calibration settings to trigger inflation at specific depths.

Upon detecting water ingress beyond a predefined threshold, the sensors transmit a signal to solenoid valves, which release pressurized gas into the airbags, initiating inflation of the airbags. The expanding airbags breach the housing and deploy through the exit structure to provide buoyancy to the vehicle.

Accordingly, the automatic vehicle buoyancy system of the present invention is particularly advantageous as it provides a system that detects water ingress and initiates a rapid flotation response that stabilizes a vehicle before full submersion of the vehicle occurs. The integration of inflatable buoyancy modules with strategically placed airbags and automated solenoid valves on the vehicle ensures activation without occupant intervention, thereby enhancing response speed and reliability. Furthermore, by preventing vehicle submersion, the system minimizes the likelihood of hazardous fluid leakage into aquatic environments and significantly reduces the need for complex recovery operations. As a result, the automatic vehicle buoyancy system offers a comprehensive solution to the problems of occupant entrapment, environmental damage, and costly salvage efforts that overcomes existing devices and methods used in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one potential embodiment of an automatic vehicle buoyancy system of the present invention while undeployed in accordance with the disclosed architecture; and

FIG. 2 illustrates a front perspective view of one potential embodiment of an automatic vehicle buoyancy system of the present invention while deployed in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an automatic vehicle buoyancy system that prevents full vehicle submersion during water ingress emergencies. There also exists a long-felt need in the art for an automatic vehicle buoyancy system that provides automated activation using onboard sensors without user intervention. Moreover, there exists a long-felt need in the art for an automatic vehicle buoyancy system that reduces environmental contamination and the logistical burden of vehicle recovery.

The present invention, in one exemplary embodiment, is comprised of an automatic vehicle buoyancy system. The system is designed to prevent complete submersion of a vehicle in scenarios involving water ingress or sinking. More specifically, by detecting submersion conditions and initiating rapid deployment of inflatable buoyancy components from the vehicle, the system functions to maintain the vehicle at or near the water’s surface. The flotation system is further designed to mitigate the risk of occupant entrapment and to facilitate post-incident recovery by stabilizing the vehicle in a buoyant state. The system may be implemented in terrestrial vehicles such as but not limited to automobiles, trucks, and buses, as well as in aerial vehicles including airplanes and helicopters. Integration of the system into said vehicles may occur during initial manufacturing or through retrofitting into existing vehicles. The device is also designed to be implemented into marine watercraft, vessels.

The flotation system comprises a plurality of buoyancy modules, each including one or more inflatable airbags, a containment housing, at least one inflation cylinder, and one or more connecting conduits. The airbags are retained in a compressed state within the housing and may be positioned in various locations throughout the vehicle, such as but not limited to wheel wells, chassis, door panels, roof structure, engine compartment, or rear compartment. Each housing is equipped with an airbag exit structure to enable rapid deployment of the airbags.

Inflation of the airbags is achieved through gas cylinders that store pressurized media, including carbon dioxide, nitrogen, or other suitable gases. The pressurized media is conveyed to the airbags via conduits. Activation of the buoyancy modules is governed by submersion sensors that are electronically linked to the vehicle’s computer system. These sensors are configured to detect water depth and include calibration settings to trigger the inflation process once specific depth thresholds are reached.

Once water ingress surpasses a predefined activation threshold, the sensors issue a signal to solenoid valves, which then release pressurized gas into the airbags, initiating their inflation. As the airbags expand, they breach the housing and deploy through the exit structure, thereby generating a buoyant force sufficient to stabilize the vehicle.

As a result, the system detects water ingress into a vehicle and promptly triggers a flotation response before the vehicle becomes fully submerged. The system activation further functions without occupant involvement, thereby improving deployment speed and reliability. In addition to preventing vehicle submersion, the system also reduces the risk of hazardous fluid release into aquatic environments and minimizes the complexity of recovery operations. Consequently, the automatic vehicle buoyancy system offers an effective solution to the challenges of occupant entrapment, environmental contamination, and costly salvage procedures, overcoming existing devices and methods known in the art.

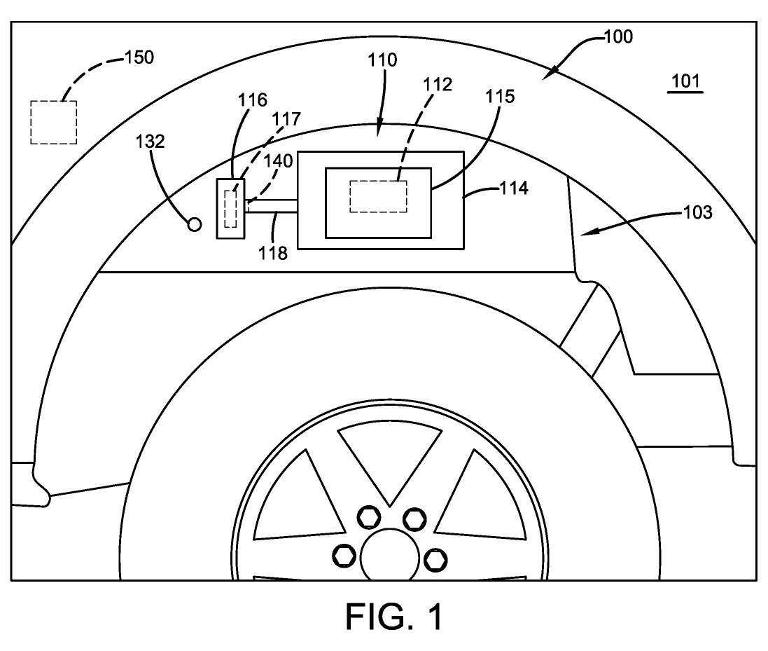

Referring initially to the drawings, FIG. 1 illustrates a front perspective view of one potential embodiment of an automatic vehicle buoyancy system 100 of the present invention while undeployed in accordance with the disclosed architecture. The system 100 is an automated flotation system that prevents a vehicle 101 from becoming fully submerged in the event of water ingress or sinking. More specifically, the system 100 detects submersion conditions and rapidly deploys inflatable buoyancy components to maintain the vehicle 101 at or near the water's surface. The system 100 is further intended to reduce the risk of occupant entrapment and improve post-incident recovery by stabilizing the vehicle 101 in a partially or fully buoyant state.

In different embodiments, the system 100 may be configured for use in a wide range of vehicles 101 such as but not limited to terrestrial vehicles like automobiles, buses, trucks, SUVs, sedans, pickup trucks, etc., aerial vehicles such as airplanes, helicopters, other aircraft that may be at risk of emergency water landings or water entry due to flooding, and other marine vessels. The system 100 may be integrated into the vehicle 101 during original manufacturing or retrofitted into existing vehicles 101.

The system 100 may be comprised of a plurality of buoyancy modules 110 that may be located anywhere on the vehicle 101. Each buoyancy module 110 may be comprised of one or more inflatable airbags 112, a containment housing 114, at least one inflation cylinder 116, and one or more connecting conduits 118. The inflatable airbags 112 may be made from flexible, high-tensile strength materials such as but not limited to any combination of thermoplastic polyurethane (TPU), reinforced nylon composites, aramid fiber laminates, silicone-coated fabrics, or synthetic elastomers with hydrophobic coatings. The airbags 112 may be configured in various forms, such as but not limited to cylindrical, toroidal, multi-cellular, bellowed, or hemispherical airbag geometries.

Each airbag 112 may be folded, rolled, or compressed into the housing 114, which may be positioned in one embodiment within or adjacent to each wheel well 103 of a vehicle 101, as seen in FIG. 1, and/or anywhere on the vehicle 101 such as but not limited to any combination of on the vehicle 101 chassis, within door panels, integrated into the vehicle roof structure, under the hood, or in the rear compartment, depending on vehicle design. Each airbag 112 may be contained within a housing 114 that is configured to fully or partially open once inflation of the airbag 112 begins, enabling the airbag 112 to deploy outwardly from the housing 114 and achieve full expansion. To do so, the housing 114 may include at least one airbag exit structure 115 such as but not limited to any combination of frangible seams, tear-away panels, hinged covers, spring-loaded doors, or sliding partitions that permit rapid and unobstructed deployment of the airbag 112 from the housing 114.

Inflation of the airbags 112 may be facilitated by one or more compressed gas cylinders 116. Each gas cylinder 116 may store inflation media 117 under high pressure, such as but not limited to any combination of carbon dioxide (CO₂), compressed air, nitrogen, helium, argon, gas mixtures, etc. Each gas cylinder 116 may be connected to a respective airbag 112 via at least one conduit 118. The conduit 118 may be comprised of but is not limited to any combination of flexible braided tubing, rigid stainless steel piping, reinforced rubber hosing, thermoplastic elastomer lines, etc.

Activation of the buoyancy modules 110 may be controlled by at least one submersion sensor 132 that may be electronically integrated into the vehicle’s 101 existing computer system, enabling coordination with other onboard safety and diagnostic systems. Each submersion sensor 132 may be comprised of any combination of hydrostatic pressure switches, capacitive fluid detectors, piezoresistive depth sensors, ultrasonic level sensors, or optical refractive index sensors. In one embodiment, at least two pressure switches 132 may be installed in concealed locations at the bottom of the vehicle 101, such as but not limited to strategic low points like underbody cavities, battery compartments, wheel wells 103, and/or footwells. Each sensor 132 may include customizable calibration settings to trigger at predefined depths, such as but not limited to two to three feet of water depth.

Upon reaching the activation threshold, the sensors 132 may transmit a signal to at least one solenoid valve 140. The solenoid valve 140 may comprise but is not limited to an electronically controlled actuator, permitting rapid release of pressurized inflation media 117 from the gas cylinder 116 into the connected airbag 112. The solenoid valve 140 may be configured to open in response to a trigger signal originating from the submersion sensor 132 or the vehicle’s computer system.

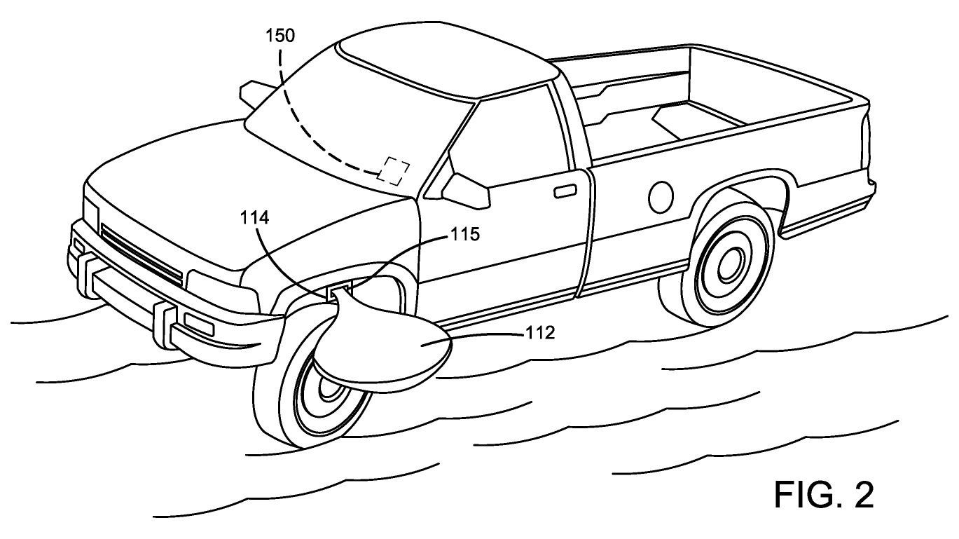

In further embodiments, activation may also be initiated manually via a manual control 150 located within the vehicle 101 cabin, as seen in FIG. 2. The manual control 150 may allow occupants to deploy the buoyancy system 100 in anticipation of water entry or in the event of sensor 132 malfunction. The control 150 may include but is not limited to a button, a switch, a virtual button on an electronic display screen of the vehicle, etc.

In operation, the system 100 may detect water depth via the pressure switches 132 and automatically activate the solenoid valves 140 when water reaches the predetermined depth threshold. Upon valve activation, compressed gas is released from the cylinders 116 and flows through the conduits 118 into the airbags 112, causing the airbag 112 to rapidly inflate. As inflation begins, the housing 114 is breached by the outward force exerted by the expanding airbag 112, causing the exit structure 115 to open and permit deployment, as seen in FIG. 2. Once deployed, the airbags 112 provide sufficient buoyant force to elevate and stabilize the vehicle 101 near the water surface, thereby preventing full submersion.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “automatic vehicle buoyancy system” and “system” are interchangeable and refer to the automatic vehicle buoyancy system 100 of the present invention.

Notwithstanding the foregoing, the automatic vehicle buoyancy system 100 of the present invention and its various components can be of any suitable size and configuration as is known in the art without affecting the overall concept of the invention, provided that they accomplish the above-stated objectives. One of ordinary skill in the art will appreciate that the size, configuration, and material of the automatic vehicle buoyancy system 100 as shown in the FIGS. are for illustrative purposes only, and that many other sizes and shapes of the automatic vehicle buoyancy system 100 are well within the scope of the present disclosure. Although the dimensions of the automatic vehicle buoyancy system 100 are important design parameters for user convenience, the automatic vehicle buoyancy system 100 may be of any size, shape, and/or configuration that ensures optimal performance during use and/or that suits the user’s needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An automatic vehicle buoyancy system comprising:
a buoyancy module positioned on a vehicle, wherein the buoyancy module is comprised of an inflatable airbag stored within a housing, a gas cylinder containing an inflation media, and a conduit connecting the gas cylinder to the airbag;
a sensor configured to detect a submersion condition of the vehicle; and
a solenoid valve configured to release the inflation media from the gas cylinder into the airbag in response to a signal from the sensor, wherein inflation of the airbag deploys the airbag from the housing to provide buoyancy to the vehicle.

2. The automatic vehicle buoyancy system of claim 1, wherein the inflation media is comprised of a carbon dioxide, a compressed air, a nitrogen, a helium, or an argon.

3. The automatic vehicle buoyancy system of claim 1, wherein the inflatable airbag is folded within the housing.

4. The automatic vehicle buoyancy system of claim 1, wherein the sensor is comprised of a hydrostatic pressure switch, a capacitive fluid detector, a piezoresistive depth sensor, an ultrasonic level sensor, or an optical refractive index sensor.

5. The automatic vehicle buoyancy system of claim 1, wherein the sensor is positioned on or inside the vehicle.

6. The automatic vehicle buoyancy system of claim 1, wherein the inflatable airbag is comprised of a cylindrical, a toroidal, a multi-cellular, a bellowed, or a hemispherical geometry.

7. An automatic vehicle buoyancy system comprising:
a buoyancy module positioned on a vehicle, wherein the buoyancy module is comprised of an inflatable airbag stored within a housing having an airbag exit structure, a gas cylinder containing an inflation media, and a conduit connecting the gas cylinder to the airbag;
a sensor configured to detect a submersion condition of the vehicle; and
a solenoid valve configured to release the inflation media from the gas cylinder into the airbag in response to a signal from the sensor, wherein inflation of the airbag deploys the airbag from the housing to provide buoyancy to the vehicle.

8. The automatic vehicle buoyancy system of claim 7, wherein the airbag exit structure is comprised of a frangible seam, a tear-away panel, a hinged cover, a spring-loaded door, or a sliding partition.

9. The automatic vehicle buoyancy system of claim 7, wherein the inflation media is comprised of a carbon dioxide, a compressed air, a nitrogen, a helium, or an argon.

10. The automatic vehicle buoyancy system of claim 7, wherein the sensor is comprised of a hydrostatic pressure switch, a capacitive fluid detector, a piezoresistive depth sensor, an ultrasonic level sensor, or an optical refractive index sensor.

11. The automatic vehicle buoyancy system of claim 7, wherein the inflatable airbag is compressed within the housing.

12. The automatic vehicle buoyancy system of claim 7, wherein the sensor is positioned on or inside the vehicle.

13. The automatic vehicle buoyancy system of claim 7, wherein the inflatable airbag is comprised of a cylindrical, a toroidal, a multi-cellular, a bellowed, or a hemispherical geometry.

14. An automatic vehicle buoyancy system comprising:
a buoyancy module positioned on a vehicle, wherein the buoyancy module is comprised of an inflatable airbag stored within a housing having an airbag exit structure, a gas cylinder containing an inflation media, and a conduit connecting the gas cylinder to the airbag;
a manual control;
a sensor configured to detect a submersion condition of the vehicle; and
a solenoid valve configured to release the inflation media from the gas cylinder into the airbag in response to a signal from the sensor, wherein inflation of the airbag deploys the airbag from the housing to provide buoyancy to the vehicle.

15. The automatic vehicle buoyancy system of claim 14, wherein the inflation media is comprised of a carbon dioxide, a compressed air, a nitrogen, a helium, or an argon.

16. The automatic vehicle buoyancy system of claim 14, wherein the sensor is comprised of a hydrostatic pressure switch, a capacitive fluid detector, a piezoresistive depth sensor, an ultrasonic level sensor, or an optical refractive index sensor.

17. The automatic vehicle buoyancy system of claim 14, wherein the manual control is positioned within the vehicle.

18. The automatic vehicle buoyancy system of claim 14, wherein the inflatable airbag is rolled within the housing.

19. The automatic vehicle buoyancy system of claim 14, wherein the sensor is positioned on or inside the vehicle.

20. The automatic vehicle buoyancy system of claim 14, wherein the manual control is comprised of a button, a switch, or a virtual button.
